(19) United States
(12) Patent Application Publication
(10) Pub. No.: US 2005/0218617 A1
(43) Pub. Date: Oct. 6, 2005

(54) Utility carts in train formation with releasable hitch device therefor and method of constructing the same

(75) Inventor: Jeffry R. Frahm, Frankenmuth, MI (US)

Correspondence Address: John D. Wright, 5291 North Colony Drive, Saginaw, MI, 48603, US

(73) Assignee: MAGLINE, INC.

(21) Appl. No.: 11/091,050

(22) Filed: Mar. 28, 2005

Related U.S. Application Data
(60) Provisional application No. 60/557,767, filed on Mar. 30, 2004.

(51) Int. Cl. B62B 3/00

(52) U.S. Cl. 280/79.3

(57) ABSTRACT

A hitch device arranged for operable attachment between a pair of carts for carrying cargo provides controlled movement of the carts in train-like formation in use. The hitch device has first and second bodies, with each body having a support member having opposite ends arranged for sliding engagement with a separate pair of upright supports of separate carts when the support members are in a first position. The first and second bodies are removable from the side rails when the respective support members are moved to a second position inclined relative to the first position. The first and second bodies have a separate link arm extending generally angularly from each of their respective support members. A fastener assembly is received to couple the link arms for controlled pivotal movement relative to one another.

### REFERENCE TO CO-PENDING APPLICATION

This application claims the benefit of U.S. Provisional Application Ser. No. 60/557,767, filed Mar. 30, 2004.

### BACKGROUND OF THE INVENTION

1. Field of the Invention

This invention relates generally to carts for transporting cargo, and more particularly to carts attachable to one another in train-like fashion.

2. Related Art

Four and six-wheeled carts are generally known for transporting objects, for example, boxes, beverages, and the like, wherein the carts have a wheel supported platform with a pair of laterally spaced uprights extending from the platform generally adjacent opposite ends of the platform. To move the cart, a user typically pushes or pulls on the uprights from either end of the cart. To move more than one cart at a time, generally, the user attaches at least a pair of carts to one another by tying the carts together with a line or rope in train-like fashion to facilitate moving an increased volume of cargo per trip. Though more cargo can be transported per trip, commonly, the user must be careful while transporting the carts in this manner as the carts often become unstable relative to one another. In particular, when two or more carts are attached to one another, and as the user moves with increased speed, the carts tend to meander relative to one another, thereby increasing the potential for the cargo to be thrown off the carts, or even having at least one of the carts inclined to tip over relative to the others.

### SUMMARY OF THE INVENTION

A hitch device arranged for operable attachment between a leading cart and a trailing cart, wherein each cart has a plurality of caster wheels and at least one pair of upright end supports with generally opposite confronting parallel portions. The hitch device has a first body having a first support member with opposite ends arranged for sliding engagement with the parallel portions of one of the carts. The ends of the first body are spaced from one another a predetermined distance so that the first body remains engaged with the end supports when the first body is in a first position. The first body is removable from the end supports when in a second position, wherein the second position is inclined relative to the first position. The hitch device has a first link arm extending generally laterally from the first support member to a free end, and a second body having a second support member with opposite ends for sliding engagement with the parallel portions of another of the pair of carts. The ends of the second body being spaced from one another a predetermined distance so that the second body remains engaged with the end supports of the cart when the second body is in a first position. The second body being removable from the end supports of the cart when in a second position, wherein the second position is inclined relative to the first position. The hitch device has a second link arm extending generally laterally from the second support member to a free end, and a pivotal restraint fastener assembly adapted to be received to join the first and second link arms for controlled pivotal movement relative to one another.

Another aspect of the invention is defined in combination with a first leading cart and a second trailing cart. The first and second carts have cargo carrying platforms supported on wheels, including caster wheels, and at least one pair of upright supports extending upwardly from each platform. Each pair of upright supports has generally opposite parallel portions with a first hitch body being releasably connected with the first cart. A first link arm extends generally angularly in a fore to aft direction from a first support member of the first body to a free end. A second hitch body is releasably connected with the second cart and a second link arm extends generally angularly in a fore to aft direction from a second support member of the second body to a free end. A fastener assembly is adapted to join the first and second link arms for restrained controlled pivotal movement of the first and second link arms relative to one another.

In another aspect of the invention, a method of constructing a train-like formation of wheel supported carts including a first leading cart and a second trailing cart is provided. The first cart and second cart are provided having cargo carrying platforms supported on wheels, including caster wheels, the carts having at least one pair of upright supports extending upwardly from the platform and being braced by at least one cross rail. Each pair of upright supports is provided having generally opposite parallel portions with confronting channels. The method comprises the steps of providing a first body having a first support member and a first link arm extending from the first support member to a free end and providing a second body having a second support member and a second link arm extending from the second support member to a free end. Then, coupling the first link arm to the second link arm with a fastener assembly for restrained controlled pivotal movement of the first and second link arms relative to one another. Further, disposing the first support member into releasable engagement with the upright supports of the first cart for relative slideable movement therewith, and disposing the second support member into releasable engagement with the upright supports of the second cart for relative slideable movement therewith.

Some of the objects, features and advantages of this invention are provided in at least some of the embodiments disclosed herein, with others being readily recognizable by one having ordinary skill in the art, wherein the hitch device includes providing an easy way to join at least a pair of carts to one another for controlled relative movement of the carts, a quick and easy way to separate the carts from one another, an ability to maneuver a considerable number of joined carts in train formation with the carts being possibly inclined relative to one another, an ability to tow two or more carts in train-like fashion at increased speeds with the carts remaining in control relative to one another, is of relatively simply design and economical to manufacture, and has a rigid and durable construction.

### BRIEF DESCRIPTION OF THE DRAWINGS

These and other objects, features and advantages of the invention will be apparent in view of the following detailed description of the presently preferred embodiments and best mode, appended claims and accompanying drawings, in which:

FIG. 1 is perspective view of a plurality of carts joined to one another by a hitch device constructed according to one presently preferred embodiment of the invention;

FIG. 2 is an exploded perspective view of the hitch device of FIG. 1;

FIG. 3 is an assembled elevation view of the hitch device of FIG. 1;

FIG. 4 is an enlarged partial view of the encircled area 4 of FIG. 3;

FIG. 5 is a partial perspective view of a cart with the hitch device shown in an initially assembled or partially removed state;

FIG. 6 is a plan view of a pair of the carts of FIG. 1 making a turning maneuver;

FIG. 7 is an elevation view of a pair of the carts of FIG. 1 with one of the carts elevated and inclined relative to the other;

FIG. 8 is a partial cross-sectional view showing a portion of the hitch device received in a channel of a side rail of one of the carts of FIG. 1;

FIG. 9 is an exploded perspective view of another embodiment of a hitch device for joining a pair of carts to one another; and

FIG. 10 is an assembled elevation view of the hitch device of FIG. 9.

### DETAILED DESCRIPTION OF THE PREFERRED EMBODIMENTS

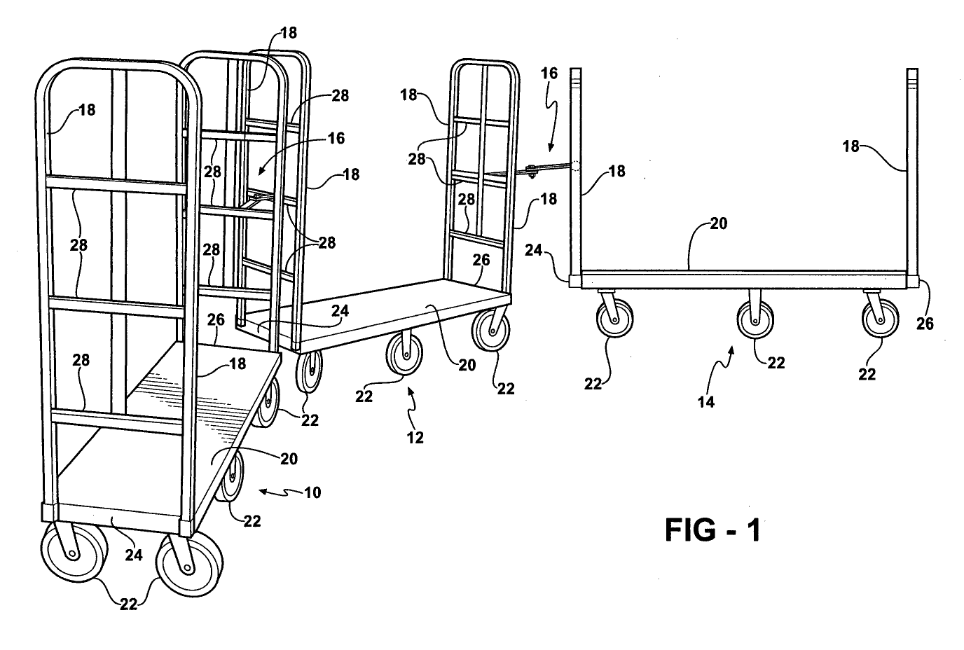

Referring in more detail to the drawings, FIG. 1 shows three carts 10, 12, 14 joined to one another in train-like fashion by hitch devices 16 constructed according to one presently preferred embodiment. Each hitch device 16 operably communicates with a pair of laterally spaced upright supports or side rails 18 on each cart 10, 12, 14 to releasably attach the carts 10, 12, 14 to one another. While the carts 10, 12, 14 are in tow, the hitch devices 16 maintain the carts 10, 12, 14 in controlled movement relative to one another along an intended path of transport. The hitch devices 16 are generally removable from the carts 10, 12, 14 to facilitate storing the carts when not in use, and to allow the carts to be moved separately from one another.

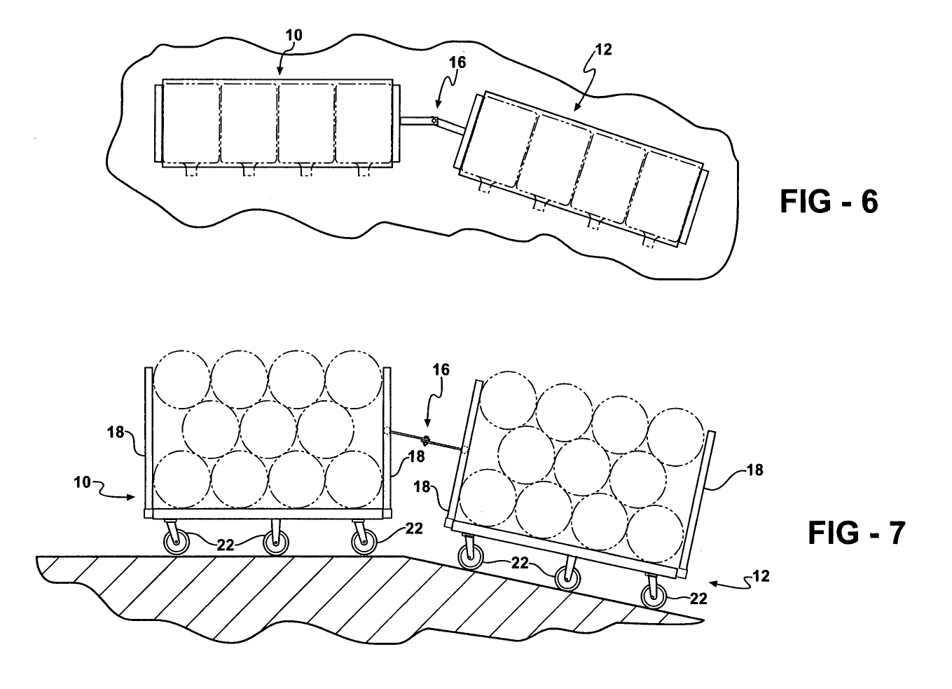

The carts 10, 12, 14 are represented here as having a platform 20 supported on six wheels 22 for carrying cargo, such as crates of beverages, for example. Generally, the wheels 22 are caster wheels that allow the carts 10, 12, 14 to be maneuvered pivotally, thus, facilitating movement of the carts 10, 12, 14 in relatively tight areas and to make relatively sharp turns (FIG. 6). The side rails 18 are located at opposite ends 24, 26 of each cart 10, 12, 14 and have cross rails 28 extending laterally or perpendicularly between the side rails 18 to provide bracing support to the side rails 18 and permitting the carts 10, 12, 14 to be pushed or pulled from either end using the side rails 18 and/or the cross rails 28.

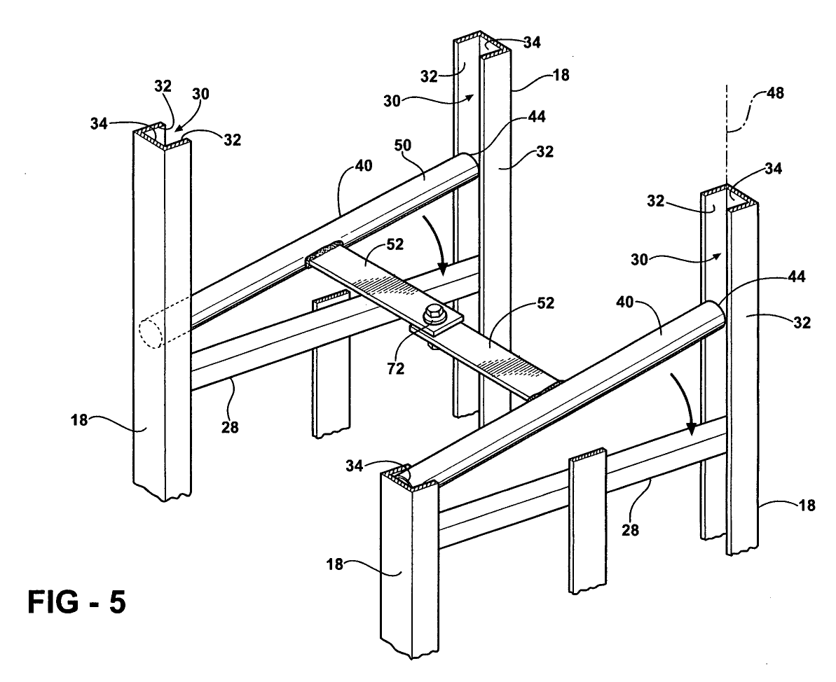

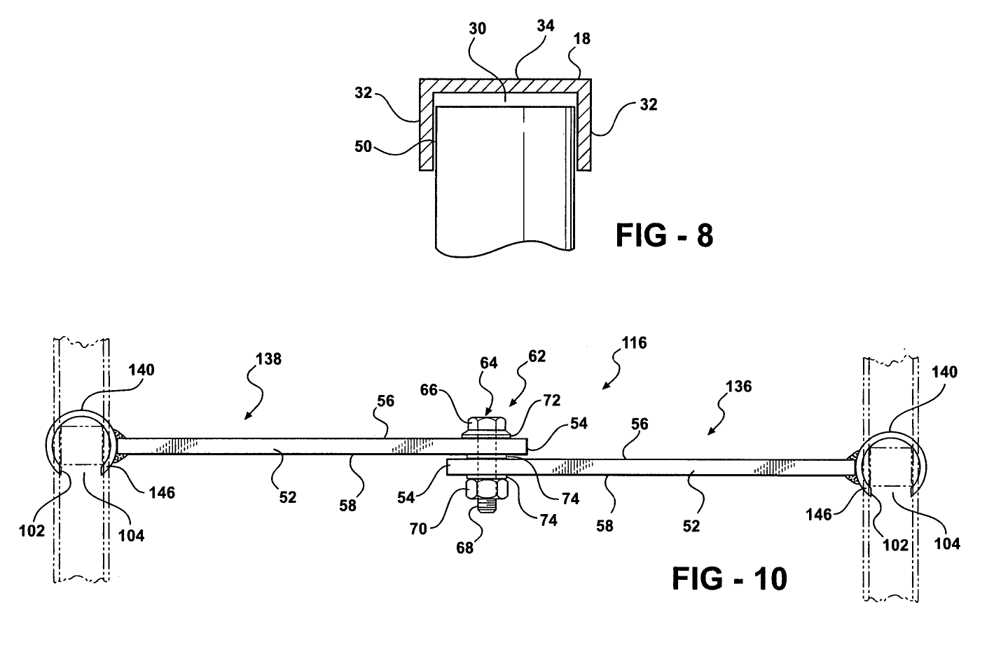

As shown in FIG. 5, the side rails 18 at the front and rear ends of each cart have generally opposite parallel portions with in-facing channels 30 formed therein and generally facing or confronting each other. As best shown in FIG. 8, taken in lateral cross-section through one of the side rails 18, the channels 30 are formed as being generally C or U-shaped by extruded walls, shown here as opposite side walls 32 joined by an end wall or web 34. The side rails 18 are spaced a predetermined distance from one another at the front and rear opposite ends 24, 26 of the carts 10, 12, 14 such that each pair of side rails, and particularly the end walls 34, are spaced generally equidistant from one another. In aligned fore to aft train formation the open faces of the channels 30 on one leading cart lie in a plane generally parallel to the plane in which the open faces of the trailing cart lie.

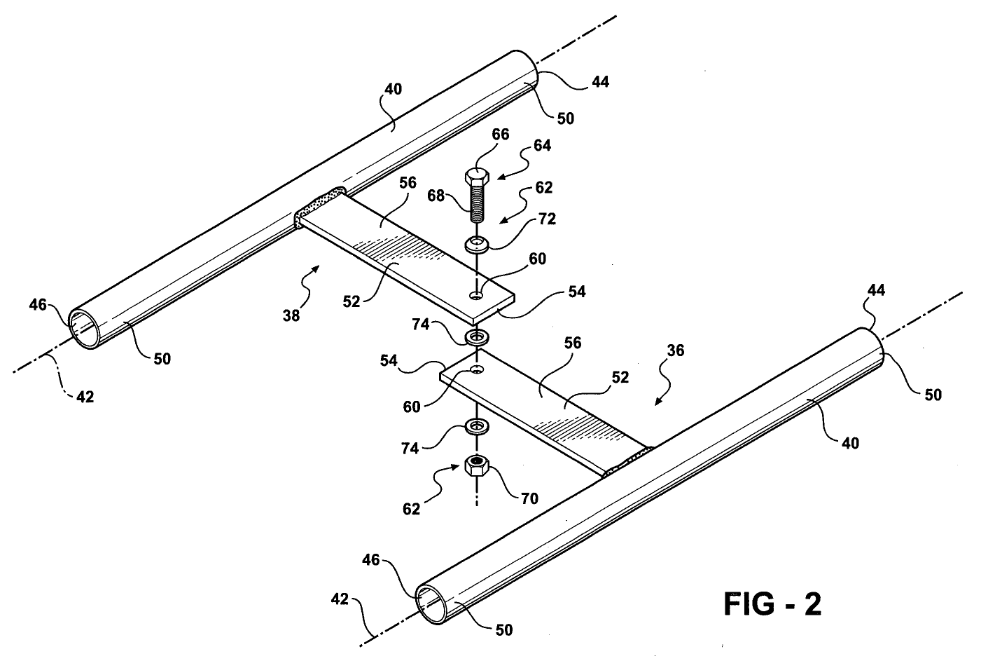

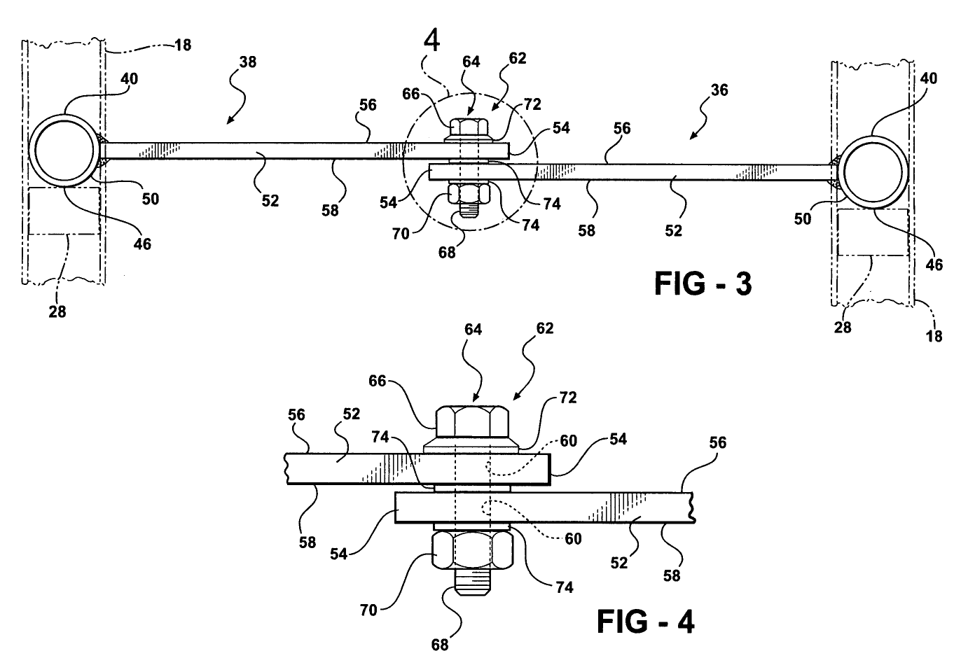

As best shown in FIGS. 2 and 3, the hitch device 16 has first and second bodies 36, 38 pivotally joined to one another in a pivotally restrained manner to facilitate towing two or more of the carts 10, 12, 14 in train-like fashion. The first and second bodies 36, 38 are generally identical in construction, and so discussion hereafter is with respect to only the first body 36, with the same reference numerals being used to represent the same features on the second body 38, unless otherwise specifically identified. The first body 36 has an elongate support member 40, represented here as a tubular support member, having a longitudinal axis 42 extending to opposite ends 44, 46. The ends 46, 48 are shaped and spaced from one another for generally sliding receipt within the opposite channels 30 of the respective carts 10, 12, 14. To facilitate maintaining the support member 40 for sliding pivotal movement within the channels 30, the ends 44, 46 of the support member 40 are generally sized for a slightly loose fit within the channels 30, while in use. Accordingly, the support member 40 has a predefined length that is slightly less than the predefined distance between the end walls 34 of the side rails 18, but long enough such that the ends 44, 46 of the support member 40 extend beyond the side walls 32, 34 and within the channels 30 when in a first position generally lateral or perpendicular to the side rails 18. When maintained between the side rails 18, the support member 40 is preferably supported by an underlying one of the cross rails 28. Desirably, the length of the support member 40 is great enough so that the support member 40 remains within the opposite channels 30 when the longitudinal axis 42 of the support member 40 is inclined generally between 90-110 degrees from a longitudinal axis 48 of each side rail 18, as shown in FIG. 5. Additionally, to facilitate pivotal movement of the support member 40 within the channels 30, thereby allowing the carts in tow to be oriented at different elevations and inclinations relative to one another (FIG. 7), generally at least a portion (FIG. 8) of the support member 40 extending axially inwardly from the ends 44, 46 has a cylindrical outer surface 50.

The first body 36 has a first link arm 52 extending generally laterally from the longitudinal axis 42 of the support member 40 to a free end 54. In construction, the link arm 52 is preferably formed as a separate piece, and thereafter attached to the support member 40, such as by a weld joint, for example. However, it should be recognized that the link arm 52 and the support member 40 could be formed as one piece, such as through injection molding a polymeric material, for example. The link arm 52 extends from the support member 40 between the ends 42, 46 of the support member 40, and preferably from a midpoint there between to a free end 54. The link arm 52 is shown having generally parallel and flat upper and lower surfaces 56, 58, respectively, with an opening 60 extending through the surfaces 56, 58 generally adjacent the free end 54. It should be recognized that other configurations for the link arm 52 are contemplated herein, such as generally cylindrical, for example.

As shown in FIG. 2, in assembling the first and second bodies 36, 38 to one another, the opening 60 of the first body 36 is generally aligned with the opening 60 of the second body 38. A fastener assembly 62, including a bolt 64 having an enlarged head 66 and a threaded shank 68 extending there from, and a nut 70, for example, is used to couple the respective link arms 52 of the first and second bodies 36, 38 to one another for controlled pivotal movement relative to one another. To facilitate controlling the pivotal movement of the link arms 52 relative to one another, a spring member 72, such as a Belleville washer, for example, is incorporated between the enlarged head 66 and the nut 70, and is shown here as being received between the enlarged head 66 and the upper surface 56 of the link arm 52 of the first body 36. The spring member 72 acts to impart a bias between the first and second link arms 52 to facilitate controlling the relative pivotal movement therebetween. In addition to the Belleville washer 72, a pair of flat washers 74, for example, are incorporated between the enlarged head 66 and the nut 70, and are shown here as being between the lower surface 58 of one link arm 52 and the upper surface 56 of the other link arm 52, and also between the nut 70 and the lower surface 58 of the link arm 52 of the second body 38.

With the Belleville washer 72 and the pair of flat washers 74 received about the threaded shank 68, the nut 70 is threadingly tightened on the shank 68 to establish a preload between the link arms 52, and in particular, between the enlarged head 66 of the bolt 64 and the nut 70. Accordingly, a predetermined minimum torque is required to pivotally move the joined link arms 52 relative to one another. A torque of near five pounds has been found to be satisfactory, however, it should be understood that the torque can be varied for other application requirements. As such, with the hitch device 16 attached between the carts 10, 12, 14, the carts 10, 12, 14 are prevented from turning relative to one another as they are being towed in a train-like fashion due to the friction imparted by the preload between the enlarged head 66, nut 70, Bellville washer 72, flat washers 74 and the link arms 52. This helps to keep the respective carts 10, 12, 14 in their intended guided train-like orientation as they are being towed, thereby allowing the user to transport the cargo on the carts 10, 12, 14 in a quicker, more safe and reliable manner.

The hitch device 16 is readily attachable and removable to and from a pair of carts 10, 12, for example, by tilting the ends 44, 46 of the support members 40 within the channels of the respective side rails 18. Generally, the longitudinal axes 42 of the support members 40 are tilted beyond 20 degrees relative to horizontal to a second position, assuming the carts 10, 12 are on a generally flat, horizontal surface, such that the ends 44, 46 can be inserted or removed from their respective channels 30. It should be recognized that the 20 degree movement allows the adjoined carts 10, 12, 14 to tilt while in tow relative to one another while still remaining attached to one another. Only when the support members 40 are tilted beyond the 20 degree orientation are the ends 44, 46 free to be removed from their respective channels 30. Accordingly, if the carts are on tilted surfaces relative to one another, the tilted hinge device remains attached between the pair of carts.

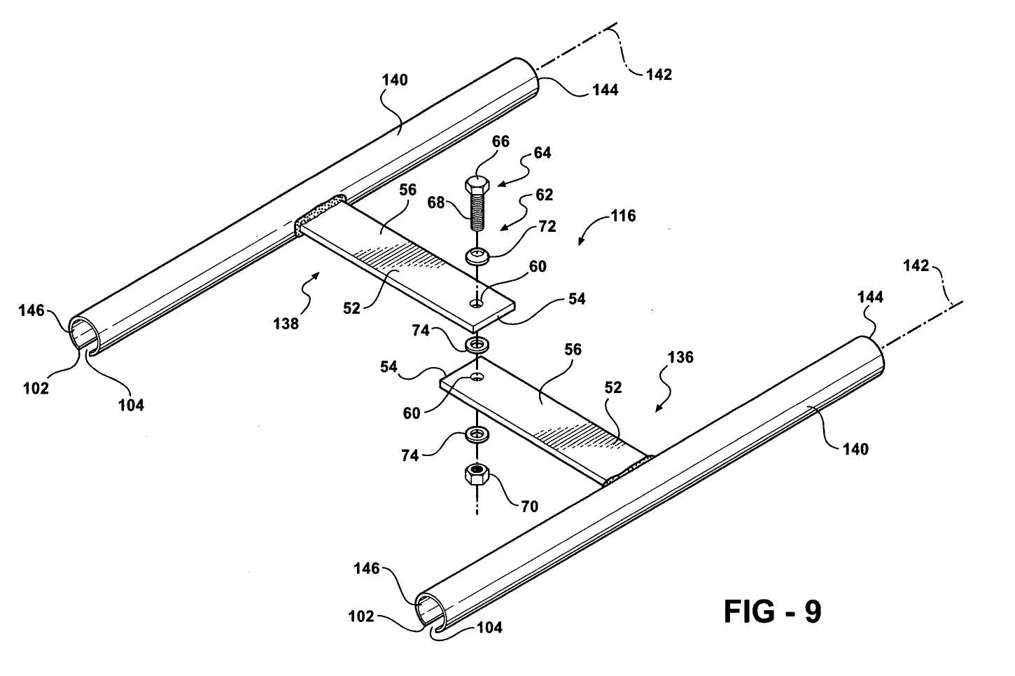

In FIGS. 9 and 10, a hitch device 116 is shown constructed to according to another presently preferred embodiment. The discussion of the hitch device 116 hereafter is limited generally to the differences from the previous embodiment, wherein the same reference numerals are used as above to designate like features. The hitch device 116 has first and second bodies 136, 138 generally identical in construction pivotally joined to one another, and so discussion hereafter is with respect to the first body 136, with the same reference numerals being used to represent the same features on the second body 138, unless otherwise specifically identified. The first body 136 has an elongate support member 140, represented here as a tubular support member, having a longitudinal axis 142 extending to opposite ends 144, 146. The resilient support member 140 has an opening or slot 102 extending along its length between the opposite ends 144, 166, wherein the slot 102 is sized for receipt of one of the cross rails 28 on the cart 12, 14, 16. Desirably, the slot 102 is sized for a snap-fit over the cross rail 28 to facilitate maintaining the support member 140 in an attached relation to the cross rail 28, while in use. It should be recognized that when a user desires to remove the hitch device 116 from one of the carts 10, 12, 14, that the support members 140 may be removed from the cross rails 28 by unsnapping the support member 140 there from.

The support members 140 are generally constructed from a polymeric material, such as polyamide (nylon), for example. As such, support members 140 are generally free to at least temporarily expand or spread open along the slot 102 to increase a gap size defined by the slot 102 so that the support members 140 may be readily snapped onto or removed from the cross rails 28. The support members 140 may be extruded, or injection molded, for example, and may be formed as a single piece of material with the link arms 52. It should be recognized that in addition to the support members 140 being snapped onto the cross rails 28, as just described, that they may be sized to function as described in the previous embodiment, so that they may be used in either manner, as desired.

It should be recognized that one having ordinary skill in the art will recognize other embodiments encompassed within the scope of this invention than those presently preferred embodiments discussed above. The embodiments described above are intended to be illustrative and not limiting. The invention is defined by the following claims.

1. A hitch device arranged for operable attachment between a leading cart and a trailing cart, each cart having a plurality of caster wheels and having at least one pair of upright end supports with generally opposite confronting parallel portions, the hitch device comprising:
a first body having a first support member with opposite ends arranged for sliding engagement with said parallel portions of one of said pair of carts, said ends being spaced from one another a predetermined distance so that said first body remains engaged with said end supports when said first body is in a first position, said first body being removable from said end supports when in a second position, said second position being inclined relative to said first position;
a first link arm extending generally laterally from said first support member to a free end;
a second body having a second support member having opposite ends for sliding engagement with said parallel portions of another of said pair of carts, said ends of said second body being spaced from one another a predetermined distance so that said second body remains engaged with said end supports of said another cart when said second body is in a first position, said second body being removable from said end supports of said another cart when in a second position, said second position of said second body being inclined relative to said first position of said second body;
a second link arm extending generally laterally from said second support member to a free end; and
a pivotal restraint fastener assembly adapted to be received to join said first and second link arms for controlled pivotal movement relative to one another.

2. The hitch device of claim 1 wherein said fastener assembly includes a spring member to facilitate controlling the pivotal movement of said first and second link arms relative to one another.

3. The hitch device of claim 2 wherein said spring member is a Belleville washer.

4. The hitch device of claim 1 wherein said first and second support members are tubular.

5. The hitch device of claim 4 wherein said first and second support members each have a slot extending along their length between said opposite ends.

6. The hitch device of claim 5 wherein said first and second support members are generally free to spread open along said slots.

7. In combination with a first leading cart and a second trailing cart having cargo carrying platforms supported on wheels, including caster wheels, said carts having at least one pair of upright supports extending upwardly from the platform, said at least one pair of upright supports having generally opposite parallel portions arranged for communication with a hitch device, said hitch device comprising:
a first body having a first support member releasably connected with said first cart;
a first link arm extending from said first support member to a free end;
a second body having a second support member releasably connected with said second cart;
a second link arm extending from said second support member to a free end; and
a fastener assembly for said first and second link arms adapted to join said first and second link arms for restrained controlled pivotal movement relative to one another.

8. The combination of claim 7 wherein said parallel portions have confronting channels and said first and second support members are sized for sliding receipt within the channels.

9. The combination of claim 8 wherein said first and second support members are maintained in said channels when in a first position, said first and second support members and being releasable from said channels when in a second position, said second position being inclined relative to said first position.

10. The combination of claim 9 wherein said first and second support members are generally perpendicular to said upright supports when in said first position.

11. The combination of claim 9 wherein said first position and said second position are inclined about 20 degrees relative to one another.

12. The combination of claim 7 wherein said first and second carts have cross rails extending between said upright supports, said first and second support members being supported by said cross members.

13. The combination of claim 12 wherein said first and second support members each have a slot extending along their length between said opposite ends, said slots being sized for receipt of said cross rails.

14. The combination of claim 13 wherein said slots are sized for a snap-fit over said cross rails.

15. The combination of claim 7 wherein said fastener assembly includes a spring member, said spring member being arranged to impart a preload between said first and second link arms.

16. A method of constructing a train-like formation of wheel supported carts including a first leading cart and a second trailing cart having cargo carrying platforms supported on wheels, including caster wheels, said carts having at least one pair of upright supports extending upwardly from the platform and being braced by at least one cross rail, said at least one pair of upright supports having generally opposite parallel portions with confronting channels, said method comprising the steps of:
providing a first body having a first support member and a first link arm extending from said first support member to a free end;
providing a second body having a second support member and a second link arm extending from said second support member to a free end;
coupling said first link arm to said second link arm via a fastener assembly for restrained controlled pivotal movement of said first and second link arms relative to one another;
disposing said first support member into releasable engagement with said upright supports of said first cart for relative slideable movement therewith; and
disposing said second support member into releasable engagement with said upright supports of said second cart for relative slideable movement therewith.

17. The method of claim 16 including tilting and disposing said first support member in said confronting channels of said first cart for slideable movement therein and tilting and disposing said second support member in said confronting channels of said second cart for slideable movement therein.

18. The method of claim 17 including tilting said first and second support members conjointly with one another to dispose said first and second members in said channels.

19. The method of claim 16 including forming said first and second support members from tubular material and forming slots along the length of said first and second support members, and disposing said slots over said cross rails of said first and second carts for releasable engagement with said cross rails.

20. The method of claim 19 including temporarily expanding said slots in said first and second support members for snapping releasable engagement with said cross rails.
